(19) United States
(12) Patent Application Publication
(10) Pub. No.: US 2002/0062272 A1
(43) Pub. Date: May 23, 2002

(54) Personalized investment consulting system implemented on network and method for the same

(76) Inventors: Kee-Woung Kim, Daejeon (KR); Uk Chang, Seoul (KR); In-Young Kim, Kyoungki-Do (KR); Jong-Won Park, Cheju-Do (KR)

Correspondence Address: PENNIE & EDMONDS LLP, 1667 K STREET NW, SUITE 1000, WASHINGTON, DC, 20006

(21) Appl. No.: 09/998,197

(22) Filed: Dec. 3, 2001

Related U.S. Application Data
(63) Continuation of application No. PCT/KR00/01441, filed on Dec. 13, 2000.

(30) Foreign Application Priority Data
Apr. 3, 2000 (KR) 2000-0017219
Apr. 3, 2000 (KR) 2000-0017218
Apr. 3, 2000 (KR) 2000-0017217
Apr. 3, 2000 (KR) 2000-0017220

(51) Int. Cl. G06F 17/60

(52) U.S. Cl. 705/36

(57) ABSTRACT

An investment consulting system executable on a computer can provide personalized investment service to a plurality of users through a network. The system includes an investment performance estimating part for periodically calculating a performance index based on a return and a risk for each investment. It also includes a client's attitude analysis part for calculating performance ranks by quantitatively grasping and synthesizing a client's investment attitude received from a communicating part, and obtaining a client index by calculating the performance ranks in terms of the same dimension as the investment performance. An asset allocation part calculates investment allocations for each kind of investment in accordance with the client's performance ranks, and reports the investment allocations to the client through the communication part. Finally, an investment selection part selects at least one investment having a small difference between the investment performance index and the client index of the requesting client in response to selection of the client, and proposes the selected investment to the client through the communication part.

### RELATED APPLICATIONS

This is a Continuation under 35 U.S.C. § 120 of the U.S. National Stage Designation of PCT/KR00/01441, filed Dec. 13, 2000.

### FIELD OF THE INVENTION

The present invention relates to an investment consulting system executable on a computer, and more particularly to an investment consulting system executable on a computer that can provide a personalized investment consulting service to a plurality of users through a network.

### BACKGROUND OF THE INVENTION

Consultation for an individual investment has been dependent upon a personal consulting with a specialist for a long time. A consultant analyzes a client's asset structure, grasps his/her investment target and attitude through an interview, and proposes an investment portfolio suitable to the client base on information on investment resources that the consultant holds.

However, the consultant's holding amount of information and analysis capability with respect to the investments may be limited. Accordingly, it is very difficult for the consultant to provide objective estimates for a number of investments in consideration of their return or variation. Further, it is ultimately impossible or very difficult to propose an optimum investment to match the client by systematically analyzing a great number of modem investments.

Conventionally, there exist web services that provide investment information to a client computer connected to a network. However, such services are limited only to database processing and proposal, and thus cannot propose an investment portfolio obtained by analyzing the information based on the generalized rule and matching the analyzed information with the client's asset structure, investment target, and investment attitude.

Further, the conventional services cannot propose an investment portfolio obtained by totally analyzing diverse investments such as stocks, bonds, funds as indirect investments, insurance, deposits, real estates, etc.

### SUMMARY OF THE INVENTION

Therefore, an object of the present invention is to solve the problems involved in the prior art, and to provide an investment consulting system that can help a person in his/her construction of the optimum investment portfolio by analyzing his/her investment attitude.

It is another object of the present invention to provide an investment consulting system that can analyze investments for diverse categories according to a personal investment attitude and guide the construction of an adequate investment portfolio with respect to the investments for the diverse categories.

It is still another object of the present invention to provide an investment consulting system that can decide adequate/inadequate for investment according to a systematic standard with respect to investments that constitute a current personal investment portfolio.

In order to accomplish the above-mentioned objects, the present invention provides an investment consulting system having a generalized quantitative estimating means with respect to diverse kinds of investments. According to this aspect, the present invention enables a unified and systematic consultation with respect to the diverse kinds of investments, and further recommendation of substitutes with respect to different kinds of investments.

In another aspect of the present invention, the investment consulting system according to the present invention proposes investments suitable to the personal investment attitude by quantitatively grasping the investment attitude for each person and matching the investment attitude with a result of quantitative estimation generally calculated.

### BRIEF DESCRIPTION OF THE DRAWINGS

The above objects, other features and advantages of the present invention will become more apparent by describing the preferred embodiment thereof with reference to the accompanying drawings, in which:

FIG. 1 is a schematic view illustrating the whole system incorporating the investment consulting system according to the present invention;

FIG. 2 is a view illustrating an example of an “asset allocation magician” menu among a financial technology menu displayed on a screen;

FIG. 3 is a view illustrating an example of a performance estimating menu displayed on a screen;

FIG. 4 is a block diagram illustrating the construction of the investment consulting system according to a preferred embodiment of the present invention; and

FIG. 5 is a flowchart illustrating an example of the process performed by an investment analysis part in FIG. 4.

### DETAILED DESCRIPTION OF THE INVENTION

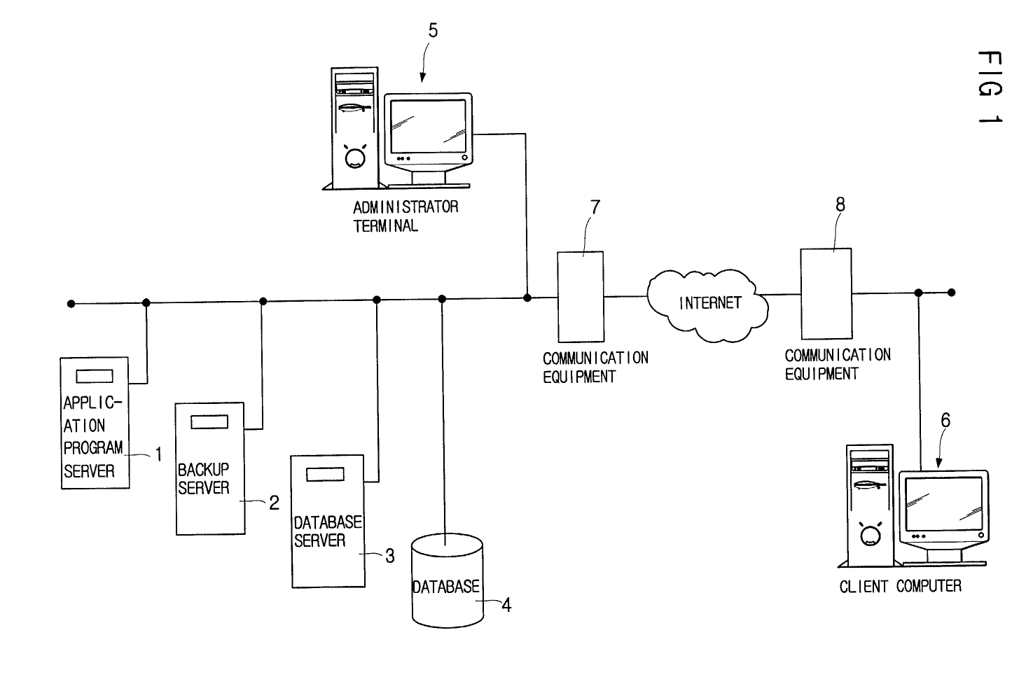

FIG. 1 is a schematic view illustrating the whole system incorporating the investment consulting system according to the present invention. Referring to FIG. 1, a service provider's equipment includes one or a plurality of servers 1, 2, and 3, and a database 4. The servers may be an application program server 1, backup server 2, and database server 3, and are managed through at lease one administrator terminal 5. A main program related to the investment consulting system according to the present invention is loaded in the application program server 1, which can be connected to a client computer 6 by identifying its domain name on the Internet. As is well known, the servers 1 to 3 are connected to network equipment 7 such as a router, selectively through security equipment. The client computer 6 may be a personal computer or a network server where a network interface is supported, and in order to execute a web browser, a graphic output device for graphic user interface and a pointing device such as a mouse are supported to the client computer 6. Also, a keyboard for a user's input of specified information is supported.

Hereinafter, for the sake of easy understanding, the investment consulting system according to an embodiment of the present invention will be explained in a client's position.

The subject of the investment consulting system according to the present invention may be diverse investments to which a person can apply his/her assets such as funds, bonds, stocks, real estates, deposits, installment deposits, insurance, etc. The investment consulting system according to the present invention provides a general menu, for example, a “financial technology” menu, for generally considering the investments. The present invention also provides a menu for a membership administration, and a menu for providing other investment information or news.

A user who intends to use the investment consulting system according to the present invention connects to the application program server 1 that executes the investment consulting system by executing the web browser through the client computer 6. Then, the user inputs his/her personal information through an entrance procedure, and registers his/her identifier (ID) and password.

After login, a member can first select the financial technology menu. However, this is not essential. Specifically, the member can use the investment consulting system according to the present invention in a manner that he/she limits his/her investments to one or several lower menus such as funds, bonds, stocks, real estates, deposits, installment deposits, insurance, etc. For instance, the member can decide to invest his/her assets only in funds, select and use a fund menu of the investment consulting system.

The financial technology menu includes menus of “my property”, “investment attitude analysis”, “asset allocation magician”, “performance estimating magician”, and “problem solution magician”. Such a menu construction forms a common flow not only in the financial technology menu that is a general menu but also in the menus of funds, bonds, stocks, real estates, deposits, installment deposits, and insurance enumerated as above. First, the member can input or identify his/her current investment state for each investment in the “my property” menu. The investment consulting system according to the present invention classifies client's investments into funds, bonds, stocks, real estates, deposits, installment deposits, insurance, etc., and further classifies them into more detailed items. For instance, the funds are classified into mutual funds and beneficiary certificates, and the stocks are classified into stocks in the Korea Stock Exchange (KSE) and stocks in the KOSDAQ market. If the client inputs a purchase date, purchase value, total amount of purchase, etc., with respect to the investments such as funds, bonds, stocks, etc., the present value and the present total amount are read out from the database periodically updated, and provided to the client.

Then, the member selects the “investment attitude analysis” menu. Through this menu, the investment consulting system according to the present invention obtains detailed investment information that cannot be obtained from the data inputted during the membership entrance. Investigation of such investment information is effected in the form of a questionnaire, being briefly classified into the economic condition of the member, expected investment return and estimation of the future economic situation, and attitude toward the investment risk. The information on the economic condition can be obtained by researches of income for a year, real estate holding status, and expenditure status. The expected investment return and the estimation of the future economic situation can be obtained by a direct question about the investment return, interest in the economic indicator, and the member's response to an assumed economic indicator. The attitude toward the investment risk can be obtained by diverse method of inquiring the member's attitude toward a game bordering on gambling. By synthetically evaluating these three attitude analyses, the investment attitude of the member is analyzed and, for example, classified into one among 7 grades such as extremely conservative (−3), conservative (−2), stable (−1), balanced, growing (+1), attacking (+2), and charging (+3).

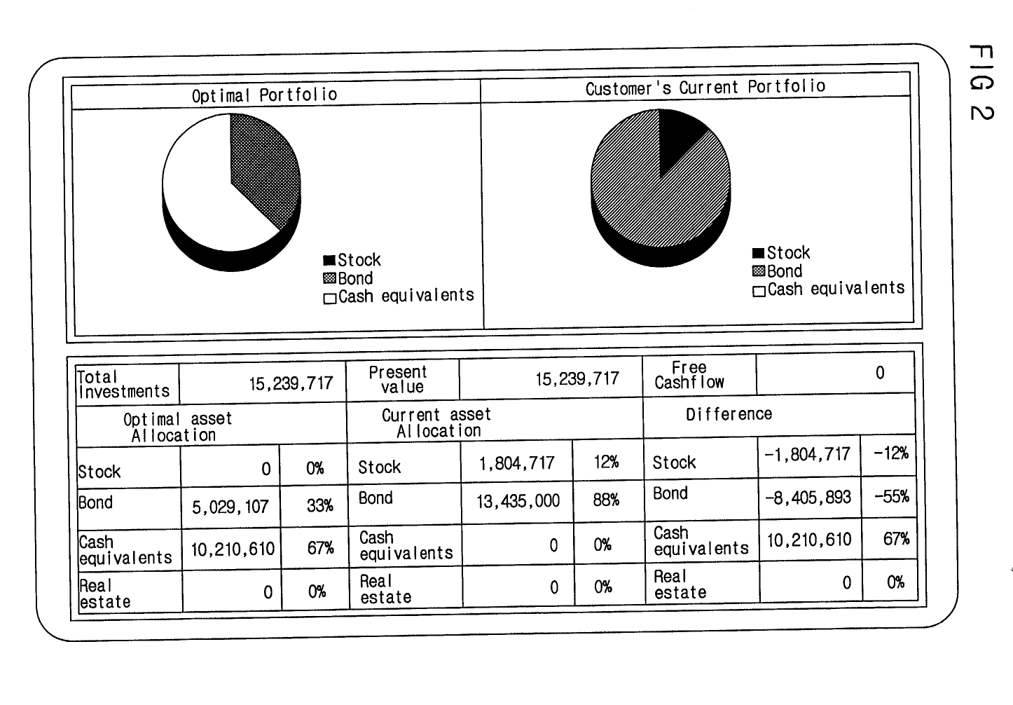

Then, the member selects the “asset allocation magician” menu. This menu presents the construction of an investment portfolio most suitable to the member and calculated according to the member's investment attitude grasped in the investment attitude analysis in comparison to the present investment portfolio inputted in the “my property” menu. However, it is also possible that the member selects the rate and sum of a portion of the investments, for example, such as the real estates, and applies more rational quantitative analysis to the remaining investments by applying the investment consulting system according to the present invention to the remaining investments. It is also possible that if the member has any spare money that has not been inputted in the “my property”, an optimum investment portfolio is proposed by additionally considering the spare money. FIG. 2 is a view illustrating an example of such an “asset allocation magician” menu displayed on a screen. As illustrated in FIG. 2, the optimum investment portfolio calculated according to the analyzed attitude is presented in comparison to the client's current investment portfolio in the form of a graph, and detailed amount of money concerned are presented in a comparing table. Through this menu, the client can visually understand his/her current investment portfolio and the optimum investment portfolio suitable to him/her. The member can compare his/her current investment portfolio with the optimum investment portfolio proposed to him/her at any time by selecting this menu.

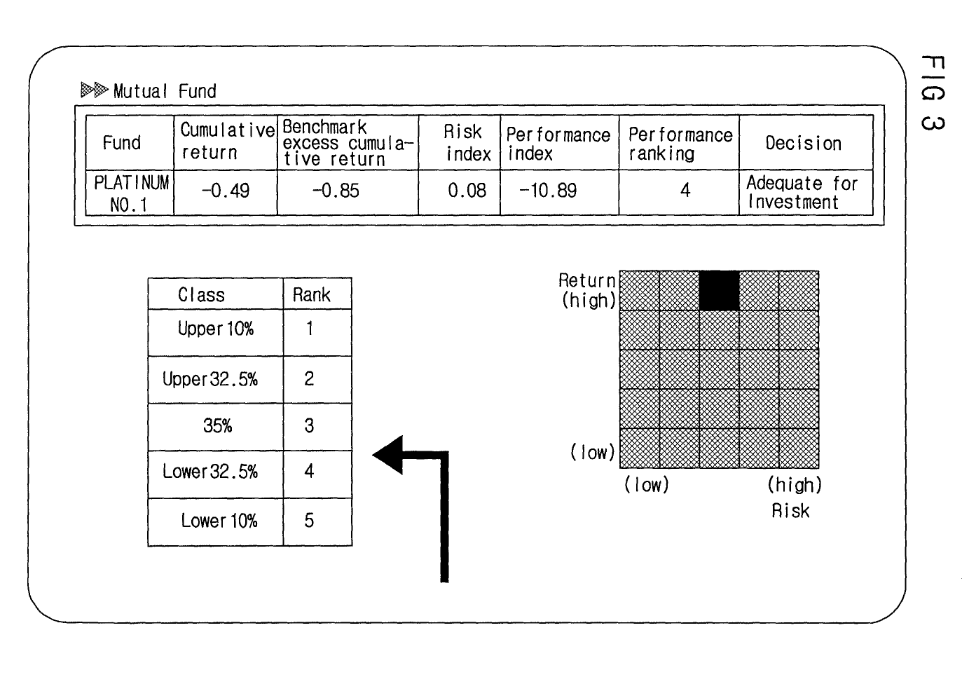

Then, the member can estimate the individual investments that constitute his/her current investment portfolio by selecting the “performance estimating magician” menu. This performance estimation is performed by proposing the adequate/inadequate for investment or the estimated profit and loss, considering the return, risk, etc., of the individual investments based on the investment attitude grasped in the investment attitude analysis. FIG. 3 is a view illustrating an example of a performance estimating menu presenting the estimation result of the individual investments. If the member selects the individual investment constituting the investment portfolio and one investment in the list of a simple decision result, the performance estimating menu is presented.

Hereinafter, a detailed estimating algorithm will be described. This estimation can be performed at any time as well as the portfolio is changed. This is because the investment performance may be changed at any time due to the variation of stock value, the variation of fund return, etc., for example. Through the above-described process, it is possible that the client objectively estimates whether the individual investment constituting his/her current portfolio is the investment suitable to his/her personalized investment attitude, i.e., the standard of the risk, target return, etc.

Then, the member selects the “problem solving magician” menu to obtain information on the investments that can substitute for the inadequate investments among the investments constituting his/her current investment portfolio. The problem solving magician proposes the investments that can substitute for the inadequate investments constituting the current portfolio based on the client's investment attitude analysis.

According to the advantageous aspect of the present invention, the investment consulting system according to the present invention can propose substitutes with respect to different kinds of investments as well as with respect to the same kind of investments. For example, it is possible that to propose a bank deposit to substitute for an inadequate fund. This is because the estimation is performed with respect to the different kinds of investments based on a unified estimation index.

Hereinafter, the whole construction of the investment consulting system according to the present invention will be explained in detail.

In one aspect of the present invention, there is provided an investment consulting system comprising a communication means, provided on a server computer that communicates with a plurality of client computers connected through a network, for performing transmission/reception of digital information with the respective client computers; a client database for storing client's investment information received from the communication means; a client's attitude analysis means for quantitatively grasping the client's investment attitude including a risk and expected return based on data of the client's investment attitude received from the communication means, and calculating a performance rank by synthesizing the client's investment attitude; and an asset allocation means for calculating an asset allocation for each kind of investment in accordance with the performance rank, and reporting asset allocation to the client through the communication means. According to this aspect of the present invention, it is possible to propose an optimum investment portfolio according to the client's investment attitude.

In another aspect of the present invention, there is provided an investment consulting system comprising a communication means for performing transmission/reception of digital information with respective client computers; an investment database for storing information on open market investments including their returns; a client database for storing client's investment information received from the communication means; a performance estimating means for periodically calculating a performance index based on a return and risk for each investment by accessing the investment database, and storing the calculated performance index for each investment in the investment database; a client's attitude analysis means for quantitatively grasping a client's investment attitude based on data of the client's investment attitude received from the communication means, and obtaining a client index by calculating the client's investment attitude in terms of the same dimension as the investment performance index to store the client index in the client database; and an investment selection means for selecting at lease one investment having a small difference between the investment performance index and the client index of the requesting client by accessing the investment database in response to selection of the client, and proposing the selected investment to the client through the communication means. According to this aspect of the present invention, it is possible to propose an investment most suitable to the client investment attitude.

The investment consulting system further comprises an investment analysis means for judging adequate/inadequate for investment based on comparison of returns for a predetermined period and a benchmark's return with respect to the object investment selected from the investments that constitute an investment portfolio of the requesting client stored in the client database in response to selection of the client, and reporting a result of judgment through the communication means. According to the aspect of the present invention, it is possible to help the client discriminate the adequate/inadequate for investment of the individual investments that constitute the client's current investment portfolio.

Hereinafter, the above-described aspects and additional aspects of the present invention will be explained in detail with reference to the accompanying drawings.

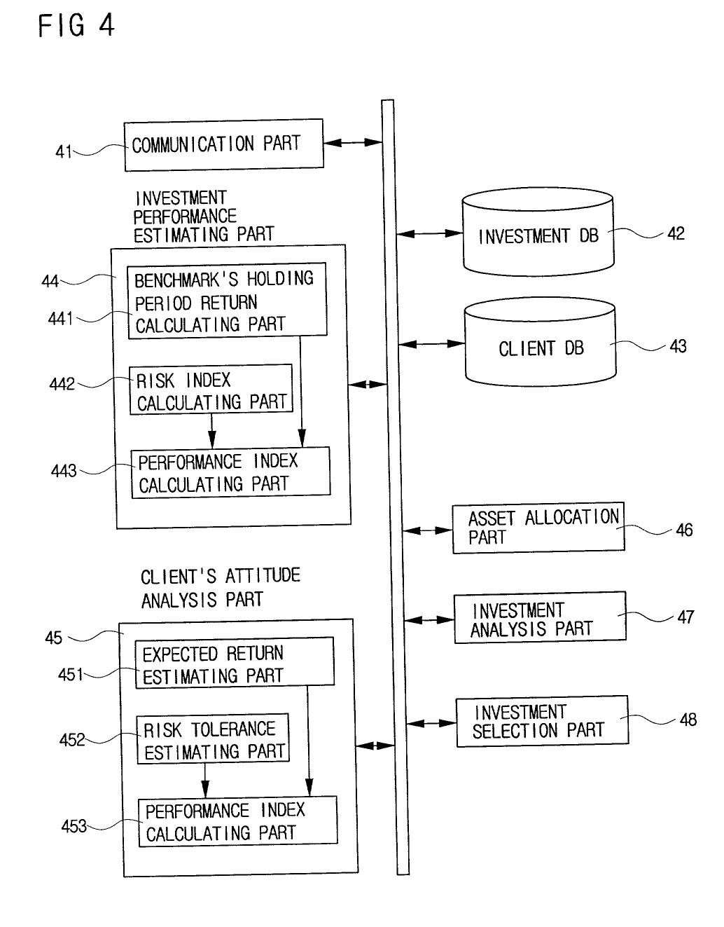

FIG. 4 is a block diagram illustrating the construction of the investment consulting system according to a preferred embodiment of the present invention. In FIG. 4, an investment resource database 42 and a client database 43 are illustrated in a separate manner. Physically, they may be separate databases installed in a single memory or in separate memories, respectively. A communication part 41 performs transmission/reception of digital information with respective client computer 6 through the Internet.

An investment performance estimating part 44 calculates returns and risks with respect to general investments stored in the investment database 42 and investments for respective clients stored in the client database 43, and calculates investment performance indexes accordingly. A client's attitude analysis part 45 transmits an inquiry to the client computer 6 through a communication part 41, and receives a response from the client computer 6, so that it estimates expected returns for each kind of client's investments accordingly, and calculates risks that the client may suffer. In addition, the client's attitude analysis part 45 grasps the investment attitude including the client's current economic condition and so on, and calculates the performance indexes for the respective clients accordingly. These performance indexes are calculated so that they correspond to the investment performance indexes grasped in the investment performance estimating part 44. An asset allocation part 46 calculates an optimum portfolio for each client based on the client's attitude quantitatively estimated by the client's attitude analysis part 45. An investment analysis part 47 receives an estimated result from the investment performance estimating part 44 with respect to the respective investments that constitute the current client's investment portfolio, and judges the adequate/inadequate for investment as shown in FIG. 3 to report the result. An investment selection part 48 proposes to the client at least one investment having a small difference between the client performance index calculated by the client's attitude analysis part 45 and the investment performance index calculated by the investment performance estimating part 44.

Hereinafter, the operation of respective function blocks of the investment consulting system according to the present invention will be explained in detail with reference to the accompanying drawings.

First, the function of the client's attitude analysis part 45 will be explained. As described above, the “investment attitude analysis” menu is executed by the “client's attitude analysis part”. The client's attitude analysis is performed through an inquiry. The client's investment attitude, which may be somewhat different according to the kinds of the investments, is briefly classified into 1) an economic condition, 2) expected return and estimation of future economic situation, and 3) attitude toward the investment risk. One or two of them may be omitted in some kinds of investments, or investigated in a different way. The basic investment attitude may include a client's current investment condition, expected investment return, attitude toward the future uncertain investment risk.

The analysis of the current economic condition is performed in a manner that an age, yearly income, future income prospect, scale of liabilities, possession/non-possession of housing, the number of dependent family, the number of years before retirement, occupation, etc., are grasped and scored, and these scores are classified into several grades, for example, upper, intermediate, and lower grades, through a statistical division to quantify them.

The grasp of the attitude toward the investment return and the expectation of the future economic situation is performed in a manner that the target investment period, target investment return, and future expected value are respectively grasped and scored by multiplying them by their weight values, and these scores are classified into several grades, for example, upper, intermediate, and lower grades, through a statistical division to quantify them.

The grasp of the attitude toward the investment risk is performed in a manner that the borne risk indexes are scored through an inquiry about a proper game, for example, a die game where its probabilities are fixed, and these scores are classified into several grades, for example, upper, intermediate, and lower grades, through a statistical division to quantify them.

By analyzing the result of such an inquiry, the performance ranks are calculated. According to the preferred embodiment of the present invention, the client's economic condition, investment return and the expectation of the future economic situation, attitude toward the risk, etc., are estimated, being divided into the three grades of upper, intermediate, and lower, and the performance rank is determined as one among 7 grades thereof by synthesizing the respective estimation values.

A high performance rank means that the expected return is high and the borne risk is low. A low performance rank means that the expected return is low and the borne risk is high. Accordingly, the expected return and the risk are divided into 4 grades, and the performance rank is dropped in case that the risk becomes higher and the expected return becomes lower, while the performance rank is raised in case that the risk becomes lower and the expected return becomes higher. This work can be properly assigned on a return-risk plane by applying the similar concept to the table of FIG. 3.

According to the client performance index calculation according to another embodiment of the present invention, the expected return is directly and indirectly determined based on the result of the inquiry. Then, since it is difficult to determine the borne risk by the inquiry, it is determined by applying a similar algorithm to the embodiment as described above. That is, the risk rank decided as a result of inquiry is calculated using the risk values for the respective investments calculated from the risk index calculating part 442 of the performance estimating part.

Specifically, the risk value for each investment obtained in the performance estimating part 44 is divided into risk ranks whose number is the same as the client's risk ranks by dividing the risk value for each kind of investments in accordance with a proper threshold value. An algorithm for obtaining the investment risk value will be explained later. Next, a representative value, for example, an average value, of the risk value for each rank of the investment is obtained. This representative value is calculated as the risk value with respect to the corresponding client's risk rank of the corresponding kind of investments.

Once the target return and the client's borne risk value are obtained, the client's target performance index is obtained from the obtained values and the benchmark's return, i.e., from the return of the representative investment. The representative investment means the investment that can be determined as the target that has the client's minimum expected return, for example, a treasury bond. An example of an algorithm for obtaining the target performance index can be expressed by the following equation.

$$Clients target performance index = \frac{target return - benchmark ' s return}{clients borne risk value} \qquad Eq . ( 1 )$$

According to the above equation, the degree that the target return deviates from the benchmark's return corresponding to a standard value is divided by the risk factor that is the standard deviation, and the degree (i.e., difference) is normalized with respect to the risk factor. After the previously calculated client performance index is calculated with respect to the investment performance index, the performance rank can be calculated by comparing the client performance index with a proper number of threshold values.

As described above, in order to select the investment in accordance with the client's attitude quantitatively grasped through the inquiry by the client's attitude analysis part 45, the performance rank should be calculated in the same dimension as the performance index of the investment. This calculation is performed in such a manner that the investments in terms of investment kinds are sorted according to the size of the performance index value and ranked as the same numbers as those of the client performance ranks, and an average performance index value of the respective ranked investments is obtained and selected as the client performance index value of the corresponding kind of investment.

According to the client performance index calculation according to still another embodiment of the present invention, since the performance rank and the performance index value have already been calculated, it is possible to compare the values with the investment performance values as they are.

Hereinafter, the function of the asset allocation part 46 will be explained. As described above according to one embodiment of the present invention, the “asset allocation magician” is implemented mainly in the asset allocation part 46. The process of the asset allocation part 46 is performed after a step of performing the inquiry about the client's investment attitude in communication with the client computer, and a step of calculating the performance rank by quantitatively grasping and synthesizing the client's investment attitude including the risk index and the expected return based on the data inputted through the inquiry. The asset allocation part 46 calculates the investment allocation for each kind of investments in accordance with the performance rank calculated as above, and reports the calculated allocation to the client.

Specifically, the asset allocation part 46 proposes a proper investment portfolio using the risk index and the average return of the investment obtained using the performance rank calculated through the above process. If the performance rank is high, it increases the investment allocation of a high-return and high-risk investment such as stocks, and if the performance rank is low, it increases the investment allocation of a banking investment such as safe deposits. According to the embodiment of the present invention, the performance ranks are classified into 7 grades, and thus the investment portfolio can be constructed by the adjustment as described above based on the standard three grades. Also, the detailed amount of investment is proposed for the respective investment from the client's current asset structure grasped by the inquiry process.

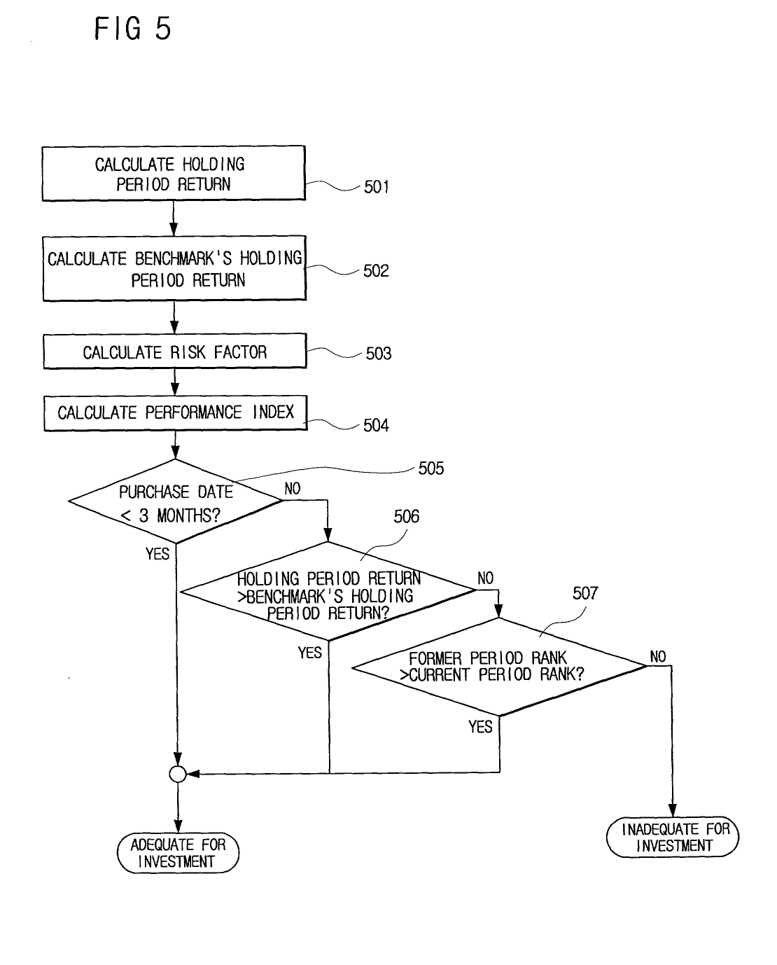

Hereinafter, the process of the investment analysis part 47 will be explained with reference to FIG. 5. In the above-described embodiment of the present invention, the “performance estimating magician” is mainly implemented by the investment analysis part 47. The function of the performance estimation can be classified into two. One is a performance estimation of the individual investments that constitute the client's current investment portfolio, and the other is periodic performance estimation for all the investments stored in the investment database 42. Though the former considers the client's holding period and the latter does not consider the client's holding period, the basic algorithms are identical.

While the client's target performance index is calculated in the above-described client's attitude analysis part 45, the target performance index of the open market investments is calculated in the investment analysis part 47. This calculation may be performed for a predetermined period, for example, once a day, in the investment performance estimating part 44, and the result of calculation may be stored in the investment database 42. However, in analyzing the investment held by a specified client, the calculation can be performed whenever it is requested based on the client's holding period.

Meanwhile, in order to analyze the client's investment portfolio, the application program server first provides to the client an input menu in the graphic environment to allow the client to input detailed information of the investments currently invested by the client, and this data is inputted to the communication part 41 through the internet. Such an investment input is extended to grasp the client's current investment portfolio by repeating the input operation with respect to all the current investments held by the client. This was explained in detail in the above-described “my property” menu.

According to the performance estimation of the investments according to the preferred embodiment of the present invention, the risk index is calculated using the difference between the benchmark's return that is the return typically required for the client's investment and the actual return of the corresponding client's investment, for example, the return just before the day or just before the month, and the performance index of the respective investment is calculated from the benchmark's return and risk index data.

FIG. 5 is a flowchart illustrating the process of the investment analysis part 47 according to a preferred embodiment of the present invention. This process is best applied to the mutual funds, and can be identically applied to other investments such as bonds in basic concept. According to the present invention, it is possible to support the unified and systematic analysis and consultation with respect to diverse investments by introducing the generalized performance estimating algorithm.

First, a holding period return is calculated with respect to the respective investment (step 501). Then, the return of the basic investment having the basic return, i.e., the benchmark's holding period return is calculated (step 502). Then, the risk factor for each investment is calculated (step 503). The risk factor means the variation of the return, and can be calculated by the standard deviation for a holding period or for a predetermined period. Thereafter, the performance index is calculated by the following formula.

$$Performance index = \frac{holding period return - benchmarks return}{risk factor}$$

The performance index is normalized by the risk factor that exceeds the benchmark's return. As the return of the investment becomes higher and the risk of the investment becomes lower, the performance index becomes higher. By comparing the performance index with predetermined threshold values, the performance ranks can be obtained. FIG. 3 shows the corresponding investment analyzed by the calculated performance index and the return-risk plane.

Thereafter, it is judged whether a predetermined period, for example, three-month period elapses after the purchase date. If not, it means that an enough holding period to enable the estimation does not elapse, and It is unconditionally judged that the investment is adequate for investment (step 505). If the holding period is enough, it is determined whether the holding period return is higher than the benchmark's holding period return. If so, it is judged that the investment is adequate for investment (step 506). Otherwise, it is determined whether the previous rank number is higher than the current rank number in the periods of the estimation standard. If so, it means that the rank is improved, and it is judged that the investment is adequate for investment (step 507). The grade is a value assigned by aligning the investments based on their returns for the estimation period. Otherwise, it is judged that the investment is inadequate for investment.

Hereinafter, a performance index calculation algorithm for each kind of investments will be explained in detail. Such an algorithm is merely an example, and the present invention is not limited thereto.

First, explanation will be made with respect to the funds. The benchmark's return of the individual investment is obtained by the following equation using the stock exchange index and the treasury bond return that is a representative investment. Here, the treasury bond return is selected as the representative investment return, considering that it is the client's minimum expected return. In the equation, KOSPI200 is selected as the stock exchange index, but one of diverse stock exchange indexes may be selected according to the kind of the client's investments.

Benchmark's return=KOSPI200×W+treasury bond return×(1−W) Eq. (2)

Here, W is properly selected in the range of 0˜1 according to the type of the corresponding investment. Examples of them are as follows.

Growth type investment: KOSPI200×0.7×treasury bond return×0.3

Stable growth type investment: KOSPI200×0.3×treasury bond return×0.7

Stable type investment: KOSPI200×0.0×treasury bond return×1.0

Using the benchmark's return and the return of the corresponding investment obtained as above, the risk factor is calculated. The risk means an average of variation of the standard return, and can be expressed by the following equation.

$$\sqrt{\frac{\begin{matrix}( Return of the corresponding investment - \\ {benchmarks return )}^{2}\end{matrix}}{elapsed days}} \qquad Eq . ( 3 )$$

Based on this risk value and the return of the corresponding investment, the performance index is calculated. An example of the calculation method is expressed by the following equation.

$$\frac{\begin{matrix}return of investment - [ return of KOSPI200 * W + \\ treasury bond return * ( 1 - W ) ]\end{matrix}}{risk factor} \qquad Eq . ( 4 )$$

Here, the denominator indicates the return of the investment that exceeds the benchmark's return.

The performance index calculated as above means data obtained by normalizing the return of the investment that exceeds the benchmark's return with respect to the risk factor.

Hereinafter, an example of a performance estimating algorithm performed for the bonds will be explained. The basic process of the bonds follows the performance estimating algorithm illustrated in FIG. 5. First, the holding period return of the individual bond is calculated (step 501). It is preferable that the calculation of the holding period return of the individual bond is performed within a definite period. In the embodiment of the present invention, the period is limited to the past one year.

$$\frac{{P}_{0}}{{( 1 + \frac{R}{m} )}^{m \times \frac{{d}_{1}}{n}}} = {\sum }_{i = 0}^{j - 1} \frac{{CR}_{i}}{{( 1 + \frac{R}{m} )}^{m \times i}} + \frac{P}{{( 1 + \frac{R}{m} )}^{\frac{{d}_{2}}{n} m \times ( j - 1 )}}$$

Here,

P₀=the oldest bond value among bond values for a year,

P=the latest bond value among bond values for a year,

R=yearly-average holding period return of the bond,

m=the number of interest payments for a year,

n=interest payment period,

d₁=the number of the remaining days until the first interest payment date within the period,

d₂=the number of the remaining days from the last interest payment date to the latest bond value application date within the period, and

j=the number of interest payments within the period.

In the embodiment of the present invention, the benchmark's return that is the standard return of the bond is determined to be the holding period return of a three-year-expired treasury bond by the following equation (step 502). However, the holding period return of the three-year-expired treasury bond issued nearest to the application date of the oldest bond value among the bond values for a year is determined as the benchmark's return.

$$\frac{{P}_{0}}{{( 1 + \frac{R}{m} )}^{m \times \frac{{d}_{1}}{n}}} = {\sum }_{i = 0}^{j - 1} \frac{{CR}_{i}}{{( 1 + \frac{R}{m} )}^{m \times i}} + \frac{P}{{( 1 + \frac{R}{m} )}^{\frac{{d}_{2}}{n} m \times ( j - 1 )}}$$

Here,

P₀=the oldest bond value among benchmark's bond values for a year,

P=the latest bond value among benchmark's bond values for a year,

R=yearly-average holding period return of the bond,

m=the number of interest payments for a year,

n=interest payment period,

d₁=the number of the remaining days until the first interest payment date within the period,

d₂=the number of the remaining days from the last interest payment date to the latest bond value application date within the period, and

j=the number of interest payments within the period.

Next, the risk factor of the bond is calculated (step 503). The risk factor is calculated by the following equation.

$$Risk factor = duration - \sqrt{\frac{1}{2} convexity}$$

Here, the calculation of the duration of the individual bond is performed according to the following equation.

$${D}_{mac} = \frac{{\sum }_{t = 1}^{T} \{ \frac{{CF}_{t}}{{( 1 + r )}^{t}} \} \times t}{{\sum }_{t = 1}^{T} \frac{{CF}_{t}}{{( 1 + r )}^{t}}} = \frac{{\sum }_{t = 1}^{T} \{ \frac{C}{{( 1 + r )}^{t}} \} \times t + \frac{F}{{( 1 + r )}^{t}}}{P}$$

Here,

D: duration,

PV(CFt): the present value of cashflow at a time poing t,

T: expiration,

P: sum of future present-values of cashflow (bond value),

r: tear-term return, and

CFt: cashfolw at a time point t.

The convexity of the individual bond is calculated by the following equation.

$$\frac{Δ P}{P} = \frac{ⅆ P}{ⅆ r} \frac{1}{P} ( Δ r ) + \frac{1}{2 !} \frac{{ⅆ}^{2} P}{ⅆ {r}^{2}} \frac{1}{P} {( Δ r )}^{2} + … + \frac{1}{n !} \frac{{ⅆ}^{n} P}{ⅆ {r}^{n}} \frac{1}{P} {( Δ r )}^{n}$$

Here, the first-order differentiation term represents the variation of the bond value measured using the duration, and the second-order differentiation term represents the variation of the bond value in consideration of the convexity of the second-order differentiation term. The sum of the three-order differentiation term to other terms becomes nearly 0, and thus the convexity of the bond will be

$$Convexity = \frac{( \frac{{B}^{″} ( r )}{2} )}{B ( r )}$$

The performance index is calculated from the convexity (step 504). The performance index is calculated by the following equation.

$$Performance index = \frac{\begin{matrix}bond holding period return - \\ treasury bond holding period return\end{matrix}}{duration - \sqrt{\frac{1}{2} convexity}}$$

The performance ranks are allocated by dividing the performance index value calculated as above into predetermined ranks in accordance with proper threshold values. For example, the performance ranks are allocated as follows.

First rank: bonds within upper 10% of the performance index

Second rank: bonds within upper 10% to 32.5% of the performance index

Third rank bonds within intermediate 35% of the performance index

Fourth rank: bonds within lower 32.5% to 10% of the performance index

Fifth rank: bonds within lower 10% of the performance index

If the performance index and the performance ranks are determined as described above, whether the investment is adequate or inadequate is estimated accordingly. First, the bond whose purchase date is less than a predetermined period, for example, three months, is unconditionally judged adequate for investment (step 505). This is because a period enough to perform the estimation does not elapse. Then, the individual holding period return is compared with the benchmark's return, and if the return is higher than the benchmark's return that is the return of the basic investment, the corresponding investment is judged adequate for investment (step 506). If the previous rank number is higher than the present rank number even in case that the return is judged not to be higher than the benchmark's return, the corresponding investment is judged adequate for investment. Otherwise, the investment is judged inadequate for investment (step 507).

Hereinafter, the performance estimating algorithm performed for stocks will be explained in detail with reference to FIG. 5. First, the holding period return of the individual stock item is calculated (step 501). This holding period return is an average return of the individual item for its holding period, and can be calculated by the following formula.

$$Holding period return = ( \frac{present value}{purchase date value} - 1 ) \times 100$$

Then, the benchmark's holding period return is calculated (step 502). The benchmark's holding period return is the holding period return of the KOSPI or KOSDAQ index for the holding period, and can be calculated by the following equation. Specifically, the KSE item is based on the standard KOSPI, and the KOSDAQ item is based on the KOSDAQ index.

$$Benchmark ' s holding period return = ( \frac{present KOSPI}{KOSPI of the purchase date} - 1 ) \times 100$$

Then, the risk factor of the investment subject to estimation is calculated (step 503). The risk factor is obtained from the standard deviation σ of the return for the holding period N.

$$σ = \sqrt{\frac{\sum {( X i - μ )}^{2}}{N}}$$

$$Risk factor = σ \sqrt{N}$$

Meanwhile, the benchmark's standard deviation σ and the risk can be calculated by the following equation.

$$σ = \sqrt{\frac{\sum {( X i - μ )}^{2}}{N}}$$

$$Risk factor = σ \sqrt{N}$$

Next, the performance index of the investment subject to estimation is calculated by the following equation (step 504).

$$Performance index = \frac{\begin{matrix}( individual item holding period return ) - \\ ( cumulative return of the one \text{-} year \text{-} expired time deposit \\ for the individual item holding period )\end{matrix}}{standard deviation \times \sqrt{\begin{matrix}holding p eriod \\ ( the number of days )\end{matrix}}}$$

Here, the cumulative return of the one-year-expired time deposit for the individual item holding period is calculated by the following formula.

$$Holding period return = interest rate of one \text{-} year \text{-} expired time deposit \times \frac{N}{365}$$

Meanwhile, the benchmark's performance index is calculated by the following formula.

$$Performance index = \frac{\begin{matrix}( benchmark ' s holding period return ) - \\ ( cumulative return of the one \text{-} year \text{-} expired time deposit \\ for the individual item holding period )\end{matrix}}{standard deviation \times \sqrt{\begin{matrix}holding p eriod \\ ( the number of day )\end{matrix}}}$$

Thereafter, the performance ranks of the investment subject to estimation are calculated based on proper threshold values. The performance ranks that can be applied to the stocks are as follows.

First rank: stocks within upper 10% of the performance index

Second rank: stocks within upper 10% to 32.5% of the performance index

Third rank: stocks within intermediate 35% of the performance index

Fourth rank: stocks within lower 32.5% to 10% of the performance index

Fifth rank: stocks within lower 10% of the performance index

In case of the stocks, the holding period is not considered in judging whether the investment is adequate or inadequate. However, the individual item holding period return is compared with the benchmark's holding period return, and if the individual item holding period return is higher than the benchmark's holding period return, the corresponding stock is judged adequate for investment (step 506). If the individual item performance index is higher than the benchmark's performance index even in case that the individual item holding period return is lower than the benchmark's holding period return, the corresponding stock is judged adequate for investment. Otherwise, the stock is judged inadequate for investment.

Hereinafter, the performance estimating algorithm performed for real estates will be explained. In performing the performance estimation, the real estates are classified into simple owned real estates and leasing real estates. In case of the simple owned real estate, the performance estimation is performed based on the transaction index variation rate instead of the return, and in case of the leasing real estate, the performance estimation is performed based on the leasing income.

First, the performance estimation with respect to the simple owned real estate will be explained. First, the transaction index variation rate of the individual real estate is calculated (step 501). The calculation of the transaction index variation rate is performed by regional groups and floor spaces, i.e., pyongs. Then, the benchmark's transaction index variation rate is calculated (step 502). This benchmark's transaction index variation rate is a value calculated with respect to the representative real estate of the respective region. This value is classified, for example, into 5 ranks in the same manner as the transaction index variation rate of the individual real estate, and the transaction index variation rate of the respective representative real estate is calculated.

Next, the risk factor σ is calculated by the following formula (step 503).

$$σ = \sqrt{\frac{\sum {( \begin{matrix}individual real estate value - \\ average of individual real estate value\end{matrix} )}^{2}}{N}}$$

Here, N is the total number of degrees of the individual real estate. Then, the performance index and the performance ranks are calculated with respect to the individual real estate (step 504). The performance index is calculated by the following formula.

$$\frac{\begin{matrix}transaction index variation rate of individual real estate - \\ benchmark ' s transaction index variation\end{matrix}}{risk factor ( σ )}$$

The performance ranks of the real estate subject to estimation are determined by dividing the performance index in accordance with proper threshold values. For example, the performance ranks can be determined from the performance index in accordance with the following basis.

First rank: real estates within upper 10% of the performance index

Second rank: real estates within upper 10% to 32.5% of the performance index

Third rank real estates within intermediate 35% of the performance index

Fourth rank: real estates within lower 32.5% to 10% of the performance index

Fifth rank: real estates within lower 10% of the performance index

If the performance index and the performance ranks are determined as described above, whether the investment is adequate or inadequate is estimated accordingly. First, the real estate whose purchase date is less than three months is unconditionally judged adequate for investment (step 505). This is because a period enough to perform the estimation does not elapse. Then, the transaction index variation rate of the individual real estate is compared with the benchmark's transaction index variation rate, and if the transaction index variation rate of the individual real estate is higher than the benchmark's transaction index variation rate, the corresponding real estate is judged adequate for investment (step 506). If the previous rank number is higher than the present rank number even in case that the transaction index variation rate of the individual real estate is judged not to be higher than the benchmark's transaction index variation rate, this means that the transaction index variation rate is improving, and thus the corresponding real estate is judged adequate for investment. Otherwise, the real estate is judged inadequate for investment (step 507).

Next, the performance estimation with respect to the leasing real estate will be explained. The performance estimating algorithm performed for the leasing real estate is the same as the algorithm for the simple owned real estate except that it is based on the leasing return instead of the transaction index variation. Specifically, the leasing return of the individual real estate is calculated (step 501). The leasing return is the profits obtained by subtracting the total expenditure and the loan refunds from the total amount of income for a month. Here, the total expenditure may include necessary expenses and taxes. The leasing return is based on the return for a unit of area, i.e., pyong, calculated by the following formula.

(Net income of real estate for a month)/(current market price of real estate)×100/(area of real estate)

Then, the benchmark's leasing return is calculated as by averaging the real estate return per unit area, i.e., pyong, by regional groups (step 502). Then the risk factor is calculated by the following formula (step 503).

$$σ = \sqrt{\frac{\sum {( \begin{matrix}net leasing income of individual real estate - \\ average of net leasing income of individual real estate\end{matrix} )}^{2}}{N}}$$

Here, N is the total number of degrees of the individual real estate. Then, the performance index and the performance ranks are calculated with respect to the individual real estate (step 504). The performance index is calculated by the following formula.

$$\frac{\begin{matrix}leasing return of individual real estate - \\ benchmarks leasing return\end{matrix}}{risk factor ( σ )}$$

The performance ranks of the real estate subject to estimation are determined based on the proper threshold values in a similar manner to the simply owned real estate.

Hereinafter, an example of the performance estimating algorithm performed for the bank deposits will be explained with reference to FIG. 11. First, the return of the individual deposit is calculated (step 501). This return is calculated as the effective return of the currently holding deposit, and the effective return means the rate obtained by yearly calculating the ratio of the investment principal (i.e., deposited principal) to the whole return get from the principal. The calculation is performed on the assumption that the principal and the interest of a short-period deposit less than one year are re-invested in the corresponding deposit, and the interest get before the expiration is added to the principal and re-invested in the corresponding deposit. At this time, the before-tax return and the after-tax return are calculated by the following formula.

$$Before \text{-} tax return ( r ) = ( \sqrt[n]{\frac{FV}{P} - 1} ) \times 100$$

$$After \text{-} tax return ( r ) = ( \sqrt[n]{\frac{FV \times ( 1 - t )}{P}} - 1 ) \times 100$$

Here,

P=investment principal

FV=future value of deposit

n=expiration of deposit

t=tax rate

The deposits are classified into a deferred type (i.e., periodic deposits) and a saving type (i.e., periodic installments) to be estimated.

Then, the benchmark's return is calculated (step 502). The benchmark's return is obtained by calculating the interest rate of the periodic deposit and the periodic installment of each bank in terms of effective return. In case of the deferred type deposit, the benchmark's return is the effective return of the periodic deposit, and in case of the saving type deposit, the benchmark's return is the effective return of the periodic installment. The effective return of the periodic deposit and the periodic installment is calculated in the same manner as the effective return of the individual investment. The bank deposit is deemed to have no risk, and thus the risk factor is 0. Then, the performance index and the performance ranks are calculated (step 504). The performance index is calculated by the following equation.

Performance index=(effective return of deposit)−(benchmark's return)

The performance ranks are determined in a manner that the performance indexes are aligned in the order of their excellence, and the performance ranks are classified into 5 ranks based on proper threshold values for example.

Hereinafter, the operation of the investment selection part 48 in FIG. 4 will be explained in detail. The function of the “problem solving magician” is mainly performed by the investment selection part 48. The investment selection part 48 proposes the investment list for each kind of investments most suitable to the client based on the client's attitude quantitatively analyzed by the client's attitude analysis part 45 and the performance index value for each investment calculated by the investment performance estimating part 44.

Specifically, the investment performance estimating part 44 repeatedly performs the step of calculating the investment performance index with respect to the open market investment in proportion to the return that exceeds the benchmark's return and in inverse proportion to the risk factor for each kind of investment portfolios. The client's attitude analysis part 45 performs the steps of performing an inquiry process about the client's attitude in communication with the client computer, quantitatively grasping the client's investment attitude including the risk and the expected return based on data inputted through the inquiry, and calculating the client's performance ranks calculated in the same dimension as the performance index of the investment. The investment selection part 48 reports for recommendation to the client computer at least one investment having the investment performance index where the difference between the client's performance index and the investment performance index becomes minimum.

As described above, the client's performance index quantitatively grasped in the client's attitude analysis part 45 is calculated in the same dimension as the performance index of the investment, and thus the client's performance index and the investment performance index can be compared with each other in the same dimension.

If the performance index of the respective investment is calculated and the client's performance index is calculated through the inquiry process, a list of an investment group where the gap, i.e., the difference between the client's performance index and the investment performance index becomes minimum, for example, 10 investments for each kind is searched as a selectable list and proposed to the client. As clearly described above, the investment list includes mutual funds, bonds, banking investments, real estates, etc. Meanwhile, since the return and the risk factor of the individual investment have been calculated, it is possible to propose a different kind of investment having the same return and low risk factor when an investment is selected from the proposed list.

Accordingly, the client can select the optimum investment, and can see the detailed information on the investment before or after selection of the investment. Also, the purchase can be guided by linking to the seller of the investment, and thereafter, the management can be processed through the same server. Diverse types of systems for purchasing the investments are known in the art, and the investment consulting system according to the present invention can achieve the purchase of the investments through an interface with such systems.

Information on various kinds of open market investments subject to the calculation of estimation indexes are now being provided from diverse institutions through on-line. For example, information related to bonds is provided from Korea Securities Software Co. Ltd., and information on mutual funds is provided from Korea Investment Trust Companies Association.

While the present invention has been illustrated and described herein with reference to the preferred embodiment thereof, it will be understood by those skilled in the art that various changes in form and details may be made therein without departing from the spirit and scope of the invention.

### Industrial Applicability

As apparent from the above description, the present invention has an advantage in that it can guide an optimum portfolio suitable to a client by an asset allocation magician function, provide a systematic analysis based on the client's current investment through a performance estimating magician, and propose an optimum investment suitable to the client's investment attitude through a problem solving magician.

What is claimed is:

1. An investment consulting system implemented on a server computer that communicates with a plurality of client computers connected through a network, the system comprising:
a communication means for performing transmission/reception of digital information with the respective client computers;
a client database for storing client's investment information received from the communication means;
a client's attitude analysis means for calculating performance ranks by quantitatively grasping and synthesizing the client's investment attitude including a risk and expected return based on data of the client's investment attitude received from the communication means; and
an asset allocation means for calculating an asset allocation for each kind of investment in accordance with the performance rank, and reporting the asset allocation to the client through the communication means.

2. An investment consulting system implemented on a server computer that communicates with a plurality of client computers connected through a network, the system comprising:
a communication means for performing transmission/reception of digital information with the respective client computers;
an investment database for storing information on open market investments including their returns;
a client database for storing client's investment information received from the communication means;
an investment performance estimating means for periodically calculating a performance index based on a return and risk for each investment by accessing the investment database, and storing the calculated performance index for each investment in the investment database;
a client's attitude analysis means for quantitatively grasping a client's investment attitude based on data of the client's investment attitude received from the communication means, and obtaining a client index by calculating the client's investment attitude in terms of the same dimension as the investment performance index to store the client index in the client database; and
an investment selection means for selecting at lease one investment having a small difference between the investment performance index and the client index of the requesting client by accessing the investment database in response to selection of the client, and proposing the selected investment to the client through the communication means.

3. The investment consulting system as claimed in claim 2, further comprising an investment analysis means for judging adequate/inadequate for investment based on comparison of returns for a predetermined period and a benchmark's return with respect to the object investment selected from the investments that constitute an investment portfolio of the requesting client stored in the client database in response to selection of the client, and reporting a result of judgement through the communication means.

4. The investment consulting system as claimed in claim 2, further comprising an investment analysis means for comparing a return for a predetermined period with a benchmark's return with respect to the object investment selected from the investments that constitute an investment portfolio of the requesting client stored in the client database in response to selection of the client, judging adequate/inadequate for investment based on a variation of the return for each standard period, and reporting a result of judgement through the communication means.

5. The investment consulting system as claimed in claim 2, further comprising a direct investment selection means for calculating a temporary performance index from a risk factor and a target return value selected by a request of the client, selecting at lease one investment where the difference between the investment performance index and the client's performance index of the requesting client is small, and proposing the selected investment to the client through the communication means.

6. The investment consulting system as claimed in claim 3, further comprising a direct investment selection means for calculating a temporary performance index from a risk factor and a target return value selected by a request of the client, selecting at lease one investment where the difference between the investment performance index and the client's performance index of the requesting client is small, and proposing the selected investment to the client through the communication means.

7. The investment consulting system as claimed in claim 4, further comprising a direct investment selection means for calculating a temporary performance index from a risk factor and a target return value selected by a request of the client, selecting at lease one investment where the difference between the investment performance index and the client's performance index of the requesting client is small, and proposing the selected investment to the client through the communication means.

8. An investment consulting system implemented on a server computer that communicates with a plurality of client computers connected through a network, the system comprising:
a communication means for performing transmission/reception of digital information with the respective client computers;
an investment database for storing information on open market investments including their returns;
a client database for storing client's investment information received from the communication means;
an investment performance estimating means for periodically calculating a performance index based on a return and risk for each investment by accessing the investment database, and storing the calculated performance index for each investment in the investment database;
a client's attitude analysis means for calculating performance ranks by quantitatively grasping and synthesizing a client's investment attitude including a risk factor and an expected return based on data of the client's investment attitude received from the communication means, and obtaining a client index by calculating the performance ranks in terms of the same dimension as the investment performance index to store the client index in the client database;
an asset allocation means for calculating investment allocations for each kind of investment in accordance with the client's performance ranks, and reporting the investment allocations to the client through the communication means; and
an investment selection means for selecting at lease one investment having a small difference between the investment performance index and the client index of the requesting client by accessing the investment database in response to selection of the client, and proposing the selected investment to the client through the communication means.

9. The investment consulting system as claimed in claim 8, further comprising an investment analysis means for judging adequate/inadequate for investment based on comparison of returns for a predetermined period and a benchmark's return with respect to the object investment selected from the investments that constitute an investment portfolio of the requesting client stored in the client database in response to selection of the client, and reporting a result of judgement through the communication means.

10. The investment consulting system as claimed in claim 8, further comprising an investment analysis means for comparing a return for a predetermined period with a benchmark's return with respect to the object investment selected from the investments that constitute an investment portfolio of the requesting client stored in the client database in response to selection of the client, judging adequate/inadequate for investment based on a variation of the return for each standard period, and reporting a result of judgement through the communication means.

11. The investment consulting system as claimed in claim 8, further comprising a direct investment selection means for calculating a temporary performance index from a risk factor and a target return value selected by a request of the client, selecting at lease one investment where the difference between the investment performance index and the client's performance index of the requesting client is small, and proposing the selected investment to the client through the communication means.

12. The investment consulting system as claimed in any claim 9, further comprising a direct investment selection means for calculating a temporary performance index from a risk factor and a target return value selected by a request of the client, selecting at lease one investment where the difference between the investment performance index and the client's performance index of the requesting client is small, and proposing the selected investment to the client through the communication means.

13. The investment consulting system as claimed in claim 10, further comprising a direct investment selection means for calculating a temporary performance index from a risk factor and a target return value selected by a request of the client, selecting at lease one investment where the difference between the investment performance index and the client's performance index of the requesting client is small, and proposing the selected investment to the client through the communication means.

14. An investment consulting method executable on a server computer that communicates with a plurality of client computers connected through a network, the method comprising the steps of:
performing an inquiry about a client's investment attitude by communication with the client computer;
calculating performance ranks by quantitatively grasping and synthesizing the client's investment attitude including a risk and an expected return based on data inputted through the inquiry; and
calculating an asset allocation for each kind of investment in accordance with the performance rank, and reporting the asset allocation to the client.

15. An investment consulting method executable on a server computer that communicates with a plurality of client computers connected through a network, the method comprising the steps of:
repeatedly performing calculation of an investment performance index with respect to an open market investment in proportion to a return that exceeds a benchmark's return and in inverse proportion to a risk factor for each kind of investment portfolios;
performing an inquiry about a client's investment attitude by communication with the client computer;
quantitatively grasping the client's investment attitude including a risk and an expected return based on data inputted through the inquiry, and calculating client performance ranks calculated in terms of the same dimension as the investment performance index; and
reporting to the client computer at least one investment having the investment performance index where the difference between the client performance index and the investment performance index becomes minimum as a recommended investment.

16. An investment consulting method executable on a server computer that communicates with a plurality of client computers connected through a network, the method comprising the steps of:
receiving information on construction of a client's current investment portfolio from the client computer;
calculating a holding period return of an individual investment constituting the portfolio;
judging the investment to be adequate for investment if the return of the individual investment is higher than a benchmark's holding period return, while proceeding to a following step if not;
judging the investment to be adequate for investment if a grade value for a previous unit estimation period is higher than a present grade value, while judging the investment to be inadequate for investment if not; and
reporting to the client computer a result of judgement for the individual investment constituting the portfolio.
